(19) United States
(12) Patent Application Publication
(10) Pub. No.: US 2024/0249633 A1
(43) Pub. Date: Jul. 25, 2024

(54) LEARNING ASSIST APPARATUS, LEARNING ASSIST METHOD, AND COMPUTER-READABLE MEDIUM

(71) Applicant: JustSystems Corporation, Tokushima (JP)

(72) Inventors: Masakazu HIRONIWA, Shinjuku-ku (JP); Fusayo TERAO, Shinjuku-ku (JP); Nobuaki WAKE, Shinjuku-ku (JP); Nahoko KAWAMURA, Shinjuku-ku (JP); Miyo KAMADA, Shinjuku-ku (JP); Yu IMOTO, Shinjuku-ku (JP)

(21) Appl. No.: 18/118,745

(22) Filed: Mar. 8, 2023

(30) Foreign Application Priority Data
Jan. 20, 2023 (JP) 2023-007047

(51) Int. Cl. G09B 7/02

(52) U.S. Cl. CPC G09B 7/02; G09B 19/025

(57) ABSTRACT

A learning assist apparatus includes at least one processor that performs, by a learning result presentation unit, presenting a learning result performed by a learner through a learner terminal. The learning result includes an answer by the learner to a learning task and process information input by the learner to the learner terminal during the process of deriving the answer. The learner terminal is equipped with a touch screen (a touch panel), and the process information is handwriting information input by the learner on the touch screen (the touch panel) during the process of deriving the answer. The learning result presentation unit presents the learning result through the learner terminal and/or an assistant terminal used by an assistant who assists the learner.

### BACKGROUND OF THE INVENTION

### 1. Field of the Invention

The present invention relates to a learning assist apparatus and the like.

### 2. Description of the Related Art

Patent Literature 1 discloses a learning assist system that accepts input of answers by a learner to questions. In accordance with the number of times incorrect answers have been input, a tailored message is displayed on a learning terminal and the learner is prompted to input a new answer.
Patent Literature 1: JP-A-2015-169844

### SUMMARY OF THE INVENTION

In the learning assist system according to Patent Literature 1, although an incorrect answer can be effectively identified, its cause is not necessarily clear. Therefore, in reviewing or reflecting on the learning results, the focus tends to be placed on the incorrect answers themselves or numerical indicators such as the percentage of correct answers, which may not lead to a fundamental solution to the cause of the incorrect answers.

The present invention was made in consideration of this situation, and its purpose is to provide a learning assist apparatus and the like that enables effective review of a learning result.

In order to solve the above issue, a learning assist apparatus in a certain aspect of the present invention includes at least one processor that performs, by a learning result presentation unit, presenting a learning result performed by a learner through a learner terminal. The learning result includes an answer by the learner to a learning task and process information input by the learner to the learner terminal during the process of deriving the answer.

According to this aspect, in a review of a learning result, not only an answer given by a learner to a learning task, but also process information that the learner input to the learner terminal during the process of deriving the answer is presented. For example, by referring to the process information in case the answer contained an error, the learner's thinking that caused the error can be effectively traced, leading to a fundamental solution to the cause of the error.

Another aspect of the present invention is a learning assist method. The method includes presenting a learning result performed by a learner through a learner terminal. The learning result includes an answer by the learner to a learning task and process information input by the learner to the learner terminal during the process of deriving the answer.

Further another aspect of the present invention is a computer-readable medium. The medium stores a learning assist program causing a computer to perform, presenting a learning result performed by a learner through a learner terminal. The learning result includes an answer by the learner to a learning task and process information input by the learner to the learner terminal during the process of deriving the answer.

In addition, any combination of the above components, and any conversion of the expression of the present invention among methods, devices, systems, recording media, computer programs and the like are also encompassed within the present invention.

According to the present invention, a learning assist apparatus and the like that enables effective review of a learning result can be provided.

### BRIEF DESCRIPTION OF THE DRAWINGS

FIG. 1 schematically shows the overall configuration of a learning assist apparatus.

FIG. 2 schematically shows an example of hardware configuration of a server.

FIG. 3 schematically shows an example of hardware configuration of a learner terminal.

FIG. 4 is a functional block diagram schematically showing the structure or the data involved in a review of learning results in a learning assist apparatus.

FIG. 5 schematically shows an example of the data structure of learning results.

FIG. 6 is a screen showing a list of learning results or achievements for each learning day of a learner.

FIG. 7 shows the detailed information of the learning results displayed when the “Show Details” button is clicked.

FIG. 8 is a screen showing a list of the results of the practice step.

FIG. 9 is a screen showing the detailed learning results.

FIG. 10 is a screen showing the detailed learning results.

FIG. 11 is a screen showing the detailed learning results.

FIG. 12 is a screen showing the detailed learning results.

### DETAILED DESCRIPTION OF THE INVENTION

The following is a detailed description of an example for implementing the present invention (hereinafter also referred to as an embodiment), with reference to the drawings. In the description and/or the drawings, identical or equivalent components, members, processes and the like will be given the same reference numbers to omit redundant descriptions. The scale or the shape of each portion illustrated is set for convenience to simplify the description, and should not be interpreted as limiting unless otherwise mentioned. The embodiments are just illustrative and do not limit the scope of the present invention in any way. Each feature described in the embodiments or any combination thereof is not necessarily essential to the present invention.

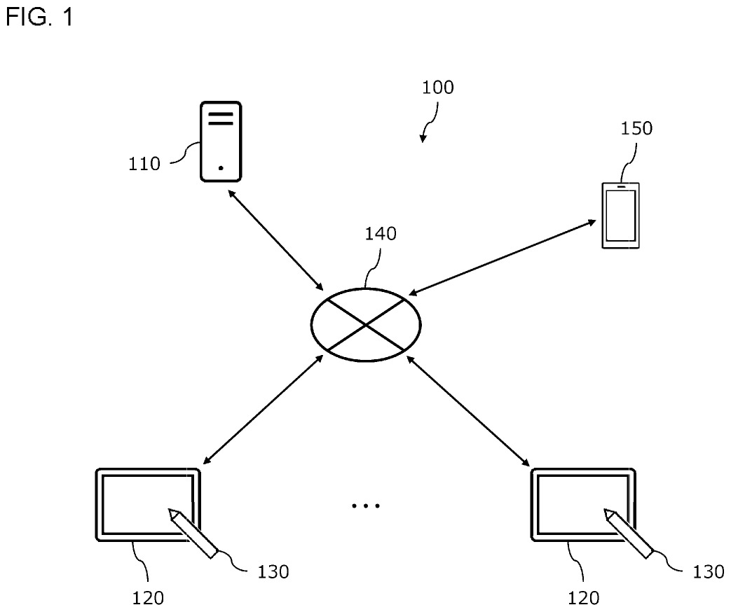

FIG. 1 schematically shows the overall configuration of the learning assist apparatus 100 according to the embodiment of the present invention. The learning assist apparatus 100 is configured by, for example, a server 110, one or more learner terminals 120, a network 140, and one or more assistant terminals 150. The server 110, the learner terminals 120, and the assistant terminals 150 are connected for mutual communication via the network 140, which is an information communication network such as the Internet.

However, as long as at least some of the operations and/or effects of the present embodiment described below are realized, all of the server 110, the learner terminal 120, and the assistant terminal 150 need not always be connected to the network 140, and at least some of them may at least temporarily operate in a stand-alone state with no connection to the network 140. For example, in case learning contents typically provided from the server 110 are pre-stored in the learner terminal 120 by pre-installation or download, learning by the learner of the learning contents and review of learning results along with the assistant, such as the learner's parent, as necessary, can be performed by the learner terminal 120 substantially in a stand-alone state.

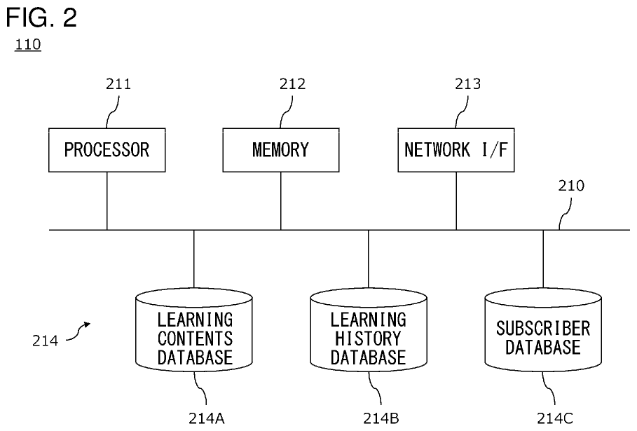

The server 110 is operated or managed by an operator or administrator such as a learning service provider that provides online learning service or remote learning service through the learning assist apparatus 100. FIG. 2 schematically shows an example of hardware configuration of the server 110. The server 110 is equipped with a processor 211, a memory 212, a network interface (I/F) 213, and a database 214, which are interconnected via a bus 210.

The processor 211 is responsible for the overall control of the server 110. The memory 212 stores various programs that can be executed by the processor 211, or various data that can be read or written by the processor 211. The memory 212 is configured by a ROM (Read-Only Memory) or a RAM (Random Access Memory), for example.

The database 214 stores various data necessary for providing the learning service. For example, the database 214 includes a learning contents database 214A that stores learning contents that can be provided to the learner terminal 120 via the network 140 (the network interface 213), a learning history database 214B that records the learning history performed by the learner through the learner terminal 120 and can be provided to the assistant terminal 150 and the like, and a subscriber database 214C that stores information concerning subscribers to the learning service, such as the learners themselves or their guardians.

The server 110 is connected to the network 140 through the network interface 213 and can communicate with the learner terminals 120 or the assistant terminals 150, which are also connected to the network 140.

In FIG. 1, the learner terminal 120 is a device used during a learning by a learner subscribing to the learning service. Although a tablet-shaped learner terminal 120 is exemplified in the present embodiment, the form of the learner terminal 120 is arbitrary as long as it can be used for a learning by a learner. For example, the learner terminal 120 may be something like a smartphone or something like a personal computer.

Regardless of the form, the learner terminal 120 is preferably equipped with the basic functions such as a receiving function (a communication function) for acquiring learning contents from the server 110 (the learning contents database 214A) via the network 140, a presentation function for presenting the learning contents to a learner through screen display or audio output, an input function for accepting the learner's input in response to the presented learning contents (e.g., an input of an answer to a presented question), and a transmitting function (a communication function) for providing the learning history of the learner to the server 110 (the learning history database 214B) via the network 140.

The learner terminal 120 may be a dedicated device customized for the learning service or a general-purpose device that can be used for purposes other than the learning service. Customization of the learner terminal 120 may be done by disabling or restricting some functions in the general-purpose device that are not used for the learning service. Especially for younger learners, it is preferable to provide customized learner terminals 120, because the learner terminal 120, if realized by a general-purpose device, may not allow the learners to concentrate on learnings (their interests may be attracted to anything other than learning).

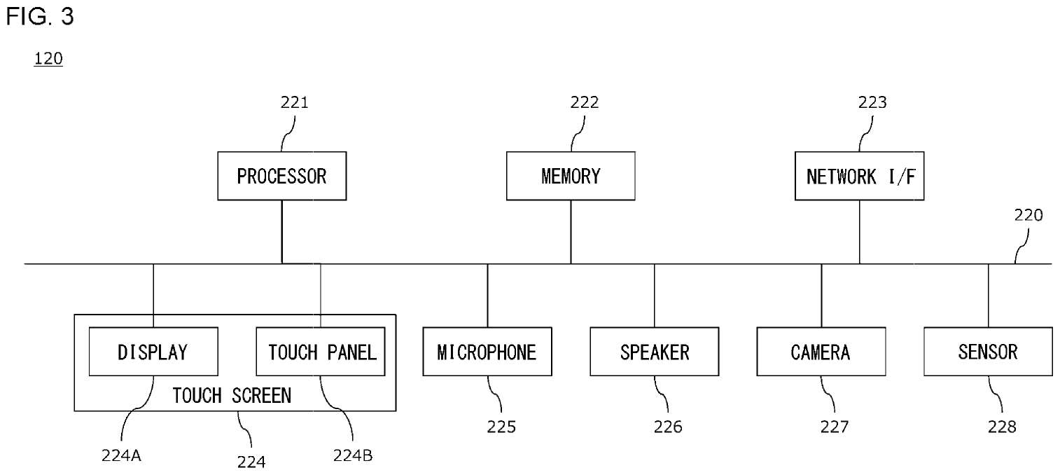

FIG. 3 schematically shows an example of hardware configuration of the learner terminal 120. The learner terminal 120 includes a processor 221, a memory 222, a network interface 223, a touch screen 224, a microphone 225, a speaker 226, a camera 227, and a sensor 228, which are interconnected via a bus 220. The processor 221 is responsible for the overall control of the learner terminal 120. The memory 222 stores various programs that can be executed by the processor 221, or various data that can be read or written by the processor 221. The memory 222 is configured by, for example, a ROM or a RAM.

The touch screen 224 is configured by a display 224A as a display device and a touch panel 224B as a position input device. Among the aforementioned basic functions of the learner terminal 120, the presentation function or the display function for presenting learning contents, menus and the like to the learner through screen display is realized by the display 224A in the touch screen 224, and the input function for accepting the learner's touch input or contact input in response to the learning contents, menus and the like displayed on the display 224A is realized by the touch panel 224B in the touch screen 224.

The presentation function in the learner terminal 120 is not limited to screen display by the display 224A, but may also be realized by audio output through the speaker 226 that may be provided in the learner terminal 120. Besides, the input function in the learner terminal 120 is not limited to touch input by the touch panel 224B, but may also be realized by voice input or audio input through the microphone 225 that may be provided in the learner terminal 120 (e.g., for use in language pronunciation practice), image input through the camera 227 that may be provided in the learner terminal 120, or measurement input through various sensors 228 that may be provided in the learner terminal 120. Examples of the sensor 228 include a temperature sensor, a humidity sensor, an electrical sensor, a magnetic sensor, an optical sensor, a mechanical sensor, an acoustic sensor, a chemical sensor, or a biological sensor.

The touch input operation to the touch screen 224 (the touch panel 224B) in the learner terminal 120 may be performed, for example, by the learner's finger, but as shown in FIG. 1, for training the writing ability of the learner, it is preferable to use a touch pen 130 (e.g., capacitive type), which is also called a stylus (or a stylus pen). In this case, the touch screen 224 in the learner terminal 120 functions as a notebook, and the touch pen 130 functions as a pen for writing on the notebook.

For example, when the learner writes characters on the touch screen 224 with the touch pen 130, the movement of the tip position of the touch pen 130 in contact or proximity to the touch screen 224 (i.e., the handwriting) is detected by the touch panel 224B. The display 224A then displays the characters according to the handwriting detected by the touch panel 224B under the control of the processor 221. In this way, the learner terminal 120 can accept the input of the handwriting information by the learner (the touch pen 130 or the finger) by the touch panel 224B in the touch screen 224, and can display (output) the handwriting information by the display 224A in the touch screen 224. It should be noted that, instead of providing (implementing) the touch panel 224B in the learner terminal 120, a touch pad externally attachable to the learner terminal 120 may be utilized to accept the input of the handwriting information by the learner.

The touch panel 224B may be capable of outputting to the processor 221 detection signals in different manners depending on the object on which the touch input operation is performed. For example, the touch panel 224B of the capacitive type outputs detection signals of different magnitudes and the like to the processor 221, based on the difference of the amount of static electricity between when a human finger of the learner and the like touches it and when the touch pen 130 touches it. The processor 221 that has recognized the object that has performed the touch input operation to the touch panel 224B may, for example, change the contents or the manners for displaying on the display 224A according to the recognized object. Besides, the learner may also change the input manner or the display manner of the handwriting information (e.g., color, thickness, or line type) by the operation on the learner terminal 120 (the touch panel 224B).

The learner terminal 120 is connected to the network 140 through the network interface 223 and can communicate with the server 110 or the assistant terminal 150, which are also connected to the network 140.

In FIG. 1, the assistant terminal 150 is a device used by an assistant who assists a learner learning using the learner terminal 120. Examples of the assistant of the learner include parents or other guardians, teachers, teaching assistants, senior students, elders and the like. The assistant terminal 150 reads the learning history performed by the learner through the learner terminal 120 from the server 110 (the learning history database 214B) via the network 140, and displays it on its display (a display device). In this way, the assistant can monitor the learner's progress or performance on the assistant terminal 150 and can provide appropriate advice or guidance for the learner as necessary.

As described below, the assistance of the learner by the assistant, such as reviewing the learning results performed by the learner through the learner terminal 120, may be conducted by the assistant at the same location as the learner, while viewing and/or operating the learner terminal 120 and/or the assistant terminal 150. Besides, in case the learner and the assistant are in different locations, the assistant (i.e., the assistant terminal 150) can provide learning assistance to the learner (i.e., the learner terminal 120) remotely, while the learner terminal 120 and the assistant terminal 150 are in communication via the network 140.

It should be noted that each learner (i.e., each learner terminal 120) and his/her assistant (i.e., the assistant terminal 150) are associated in the subscriber database 214C in the server 110. Therefore, each assistant (i.e., each assistant terminal 150) can access only the learning history of the learner (i.e., the learner terminal 120) who is registered in the subscriber database 214C as receiving his/her assistance.

The assistant terminal 150 may be similar to the learner terminal 120 also shown in FIG. 3, but components for learning purpose only such as the touch pen 130, for example, may be omitted, because they are not necessarily required by the assistant. Besides, compared to the relatively large screen of the learner terminal 120 which functions as a notebook, the screen size of the assistant terminal 150, whose main purpose is to view the learning history, may be smaller. For example, while the learner terminal 120 is a tablet, the assistant terminal 150 may be a smartphone.

Besides, while the learner terminal 120, which is typically used by younger learners (e.g., preschoolers, elementary school students, or junior high school students), can be customized (typically by restricting unnecessary functions) for the learning service, the assistant terminal 150, which is used by the learner's parents or other guardians, requires no or less customization. Thus, for example, a general-purpose device (e.g., a smartphone, a tablet, or a personal computer) used by the learner's parents or other guardians may be used as the assistant terminal 150 as is.

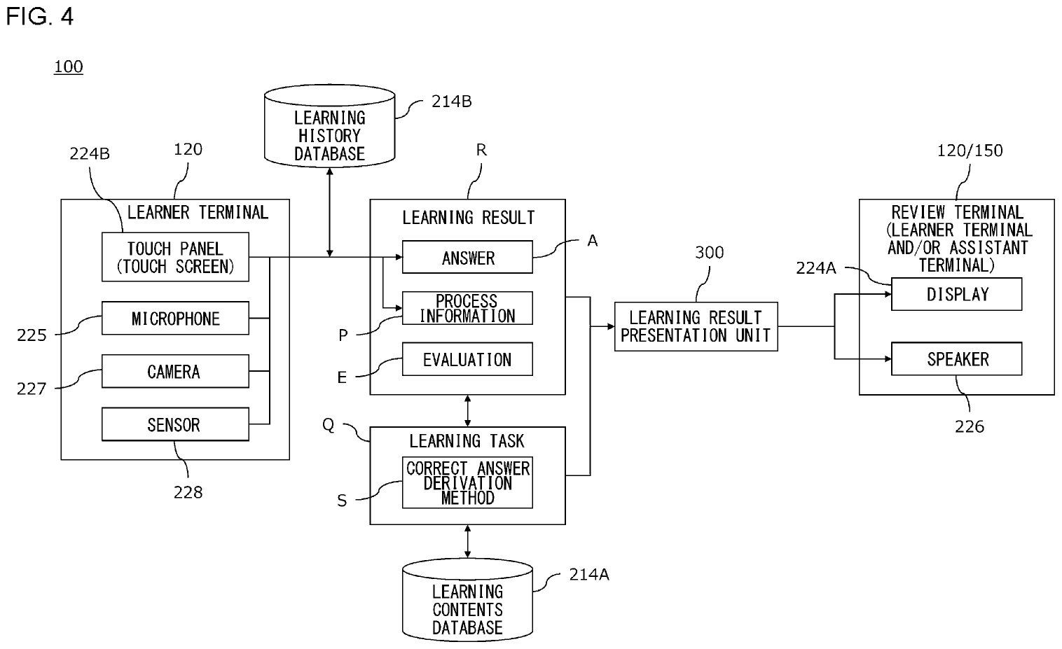

The review of learning results through the learning assist apparatus 100 according to the embodiment of the present invention will now be described. FIG. 4 is a functional block diagram schematically showing the configuration and the data involved in the review of the learning result R in the learning assist apparatus 100. The learning assist apparatus 100 includes a learning result presentation unit 300. A portion of the learning result presentation unit 300 can be omitted as long as the leaning assist apparatus 100 realizes at least some of the operations and/or effects described below. the learning result presentation unit 300 is realized by the cooperation of hardware resources, such as the central processing unit, memory, input devices, output devices, and peripheral devices connected to the computer, and software that is executed using them. Regardless of the type of computer or its installation location, each portion of the learning result presentation unit 300 may be realized with the hardware resources of a single computer, or by combining hardware resources distributed across multiple computers. Especially in the present embodiment, a portion or all of the learning result presentation unit 300 may be realized in a centralized or distributed manner by computer and/or processor provided in the server 110, the learner terminal 120, or the assistant terminal 150.

The learning result presentation unit 300 presents the learning result R performed by the learner through the learner terminal 120. The presentation of the learning result R by the learning result presentation unit 300 is conducted to a review terminal 120/150. The review terminal 120/150 is the learner terminal 120 and/or the assistant terminal 150.

The review of the learning result R using the review terminal 120/150 may be conducted solely by the learner himself/herself or solely by the assistant such as a guardian of the learner, but the present embodiment will describe a case in which both the learner and the assistant conduct the review together. However, the learner and the assistant do not necessarily have to be in the same location, and in case the learner and the assistant are in different locations, the review of the learning result R can be interactively conducted online, through the learner terminal 120 and the assistant terminal 150 (both functioning as the review terminals) which are interconnected via the network 140.

If the learner and the assistant are in the same location, the review of the learning result R may be conducted using one of the learner terminal 120 and the assistant terminal 150, preferably the learner terminal 120, as the review terminal. In this case, the learner and the assistant review together the learning result R presented through the review terminal 120/150, while viewing and/or operating the one review terminal 120/150.

It should be noted, even if the learner and the assistant are in the same location, the review of the learning result R may be conducted, using both the learner terminal 120 and the assistant terminal 150 as the review terminals. In this case, the learner terminal 120 and the assistant terminal 150 may present the same contents (e.g., the learning result R), or they may present different contents. For example, the learner terminal 120 may present contents primarily for the learner and the assistant terminal 150 may present contents primarily for the assistant. Specifically, only the assistant terminal 150 may present the contents for the assistant such as the correct answer derivation method S and other instructional methods described below, so that the assistant can effectively instruct the learner while referring to the correct answer derivation method S and other instructional methods.

If the learner and the assistant are in different locations, both the learner terminal 120 and the assistant terminal 150, which are interconnected via the network 140, are used as the review terminals to conduct the review of the learning result R. In this case, the learner views the learning result R presented through the learner terminal 120 and the assistant views the learning result R presented through the assistant terminal 150, to interactively review online the common learning result R. As mentioned above, the learner terminal 120 and the assistant terminal 150 may present different contents (e.g., only the assistant terminal 150 presents the correct answer derivation method S and other instructional methods to the assistant).

The learning result presentation unit 300 presents the learning result R to the learner and/or the assistant, through the display 224A, the speaker 226, and other presentation means or output means in the review terminal 120/150. Specific examples will be described below, but the display 224A presents the learning result R to the learner and/or the assistant through screen display. The speaker 226 presents the learning result R to the learner and/or the assistant through audio output.

The learning result R provided by the learning result presentation unit 300 to the review terminal 120/150 is based on the learning history performed by the learner through the learner terminal 120. Specifically, various data input during the learning by the learner, by various input means (the touch panel 224B, the microphone 225, the camera 227, the sensor 228, and the like) of the learner terminal 120, constitute the learning result R. These various input data (the learning history or the learning result R) are recorded in the learning history database 214B in the server 110. The learning result presentation unit 300 reads the learning result R from the learning history database 214B and provides it to the review terminal 120/150 when the learning result R is reviewed.

While specific examples will be described below, the learning result R is typically the result or the performance (e.g., score or grade) of the learning by the learner for each learning task Q. The learning task Q may be expressed as a question, an assignment, a quiz, and the like. In a typical case, a learning task Q is given an answer A input by the learner using various input means of the learner terminal 120 (in particular, the touch panel 224B or the microphone 225), for which an evaluation E is given, such as correctness, score, and the like. In addition to the answer A and the evaluation E, the learning result R in the present embodiment also includes process information P input by the various input means of the learner terminal 120 (the touch panel 224B, the microphone 225, the camera 227, the sensor 228, and the like) while the learner was deriving the answer A.

It should be noted that the learning task Q, which is metadata of the learning result R, is stored in the learning contents database 214A in the server 110. The learning contents database 214A also stores the correct answer derivation method S for each learning task Q. As described below, the correct answer derivation method S is used, for example, when reviewing the learning result R in the review terminal 120/150. Besides, when the learning assist apparatus 100 gives an evaluation E, such as a score, to the learner's answer A for a learning task Q, it may consider the degree of match between the answer A or the process information P and the correct answer derivation method S (For example, the higher the degree of match, the higher the score is given as the evaluation E).

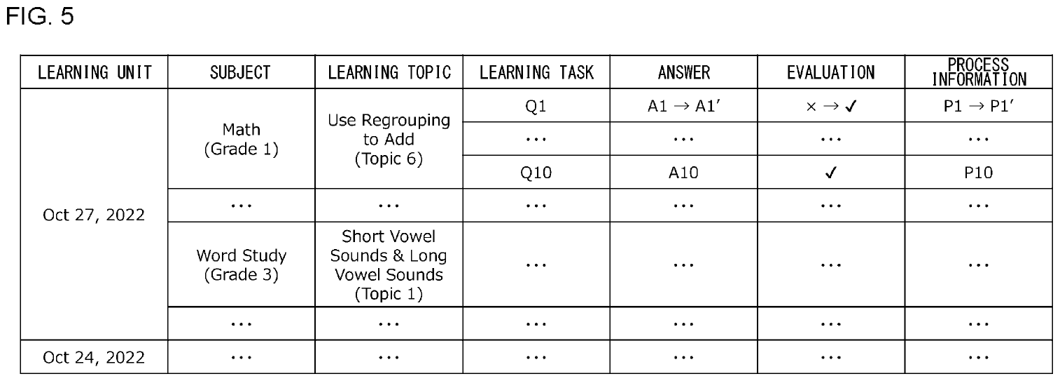

Next, a specific example of the review of the learning result R through the learning assist apparatus 100 according to the embodiment of the present invention will be described. FIG. 5 schematically shows the data structure of the learning result R in the present example. The data constituting the present data structure is obtained from at least one of the learning contents database 214A and the learning history database 214B in the server 110. Specifically, the data of “learning unit”, “subject”, “learning topic”, and “learning task” are mainly obtained from the learning contents database 214A, while the data of “answer”, “evaluation”, and “process information” are mainly obtained from the learning history database 214B.

The “learning unit” is a unit of learning that the learner performs through the learner terminal 120. One learning unit is configured by, for example, at least one “subject”, at least one “learning topic”, and at least one “learning task. The “learning unit” in the illustrated example is a “day” as a unit learning period. For example, “Oct 27, 2022” (Oct. 27, 2022) as a learning unit and a unit learning period includes multiple subjects including “Math (Grade 1)” and “Word Study (Grade 3)”. The learning unit “Oct 27, 2022” contains the result of the learning performed by the learner on Oct. 27, 2022. In this way, the data structure that uses “day” as the learning unit and the unit learning period, can effectively record the learning result or the achievement (Daily Achievement) by the learner for each learning day.

It should be noted that the learning unit and the unit learning period can be any learning period, not limited to “day”, for example, “semester”, “month”, “week”, “half day”, “hour”, or “minute. Besides, the learning unit is not limited to a learning period such as “day”, but may also be based on any component of the learning contents stored in the learning contents database 214A, such as “chapter”, “subject”, “learning topic”, or “learning task”.

As mentioned above, “Oct 27, 2022” as a learning unit and a unit learning period includes multiple subjects including “Math (Grade 1)” and “Word Study (Grade 3)”. In other words, it is recorded that the learner studied those multiple subjects on Oct 27, 2022 through the learner terminal 120.

Each “subject” may include at least one “learning topic”. In the illustrated example, the subject “Math (Grade 1)” includes one learning topic “Use Regrouping to Add (Topic 6)” and the subject “Word Study (Grade 3)” includes one learning topic “Short Vowel Sounds & Long Vowel Sounds (Topic 1)”.

Each “learning topic” may include at least one “learning task” (corresponding to the learning task Q in FIG. 4). In the example shown in the figure, the learning topic “Use Regrouping to Add (Topic 6)” contains 10 learning tasks “Q1” through “Q10”.

The “Answer” (corresponding to the answer A in FIG. 4) is an answer given by the learner (the learner terminal 120) to each “Learning Task. In the example shown in the figure, the first answer “A1” and the second answer “A1′” in a retry after the incorrect answer (A1) are recorded for the learning task “Q1”, and the answer “A10” is recorded for the learning task “Q10.

The “evaluation” (corresponding to the evaluation E in FIG. 4) is an evaluation, such as correctness, score, and the like, given by the learning assist apparatus 100 to the “answer”. In the example shown in the figure, the first answer “A1” to the learning task “Q1” is given the evaluation “incorrect” (denoted by “X”) indicating the answer (A1) was incorrect, the second answer “A1′” to the learning task “Q1” is given the evaluation “correct” (denoted by a check mark) indicating the answer (A1′) was correct, and the answer “A10” to the learning task “Q10” is given the evaluation “correct” indicating the answer (A10) was correct.

The “process information” (corresponding to the process information P in FIG. 4) is the information input by the learner to the learner terminal 120 during the process of deriving the “answer”. In the example shown in the figure, the process information “P1” is recorded when deriving the first answer “A1” to the learning task “Q1”, the process information “P1′” is recorded when deriving the second answer “A1′”, and the process information “P10” is recorded when deriving the answer “A10” to the learning task “Q10”.

Next, specific examples of screen display on the display 224A of the review terminal 120/150 based on the learning result R shown in FIG. 5 will be described. It should be noted that the following screen display examples are mainly for the case where the review terminal 120/150 is a tablet-shaped learner terminal 120 with a relatively large screen. On the other hand, in case the review terminal 120/150 is a smartphone-shaped assistant terminal 150 with a relatively small screen, each element in the following screen display examples (especially elements that are not essential in reviewing the learning result R) may be simplified or omitted. In other words, on the screen when the learner terminal 120 is used as the review terminal 120/150, it is preferable to display as much detailed information as possible that can be useful in reviewing the learning result R without interfering with visibility and operability. On the other hand, on the screen when the assistant terminal 150 is used as the review terminal 120/150, it is preferable to simplify the display so that essential elements can be grasped quickly and accurately in the review of the learning result R.

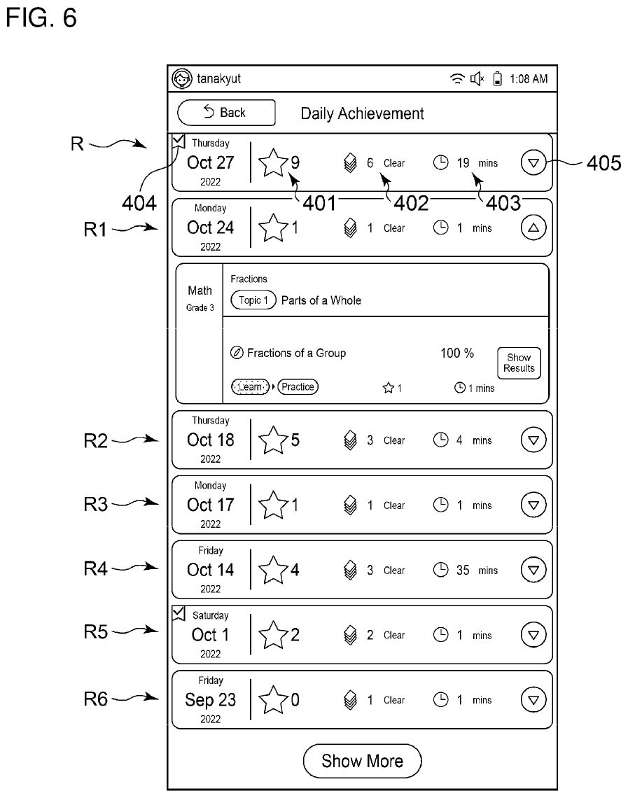

FIG. 6 is a screen listing the learning result or the achievement (Daily Achievement) of the learner for each learning day. The learning results R, R1, R2, R3, R4, R5, and R6 for each learning day as the learning unit shown in FIG. 5 are listed from top to bottom. In this way, the learning result presentation unit 300 in FIG. 4 presents the learning results R, R1, R2, R3, R4, R5, and R6 for each predetermined learning unit or for each predetermined unit learning period.

The learning result for each day displays a summary of the number of rewards (such as stars) 401 earned by the learner depending on his/her performance and the like, the number of learning topics and other items cleared 402, and the learning time 403, and the like. An achievement flag 404 indicates that the learner completed all items to be studied on each learning day (i.e., achieved the learning goal for the day). When a details-showing button 405 is pressed on the display 224A, the detailed information such as the subjects, learning topics, and the like studied on the learning day is displayed or expanded. In FIG. 6, the detail-showing button 405 for “Oct 24, 2022” (Oct. 24, 2022) is pressed, and the detailed information of the learning result R1 is displayed.

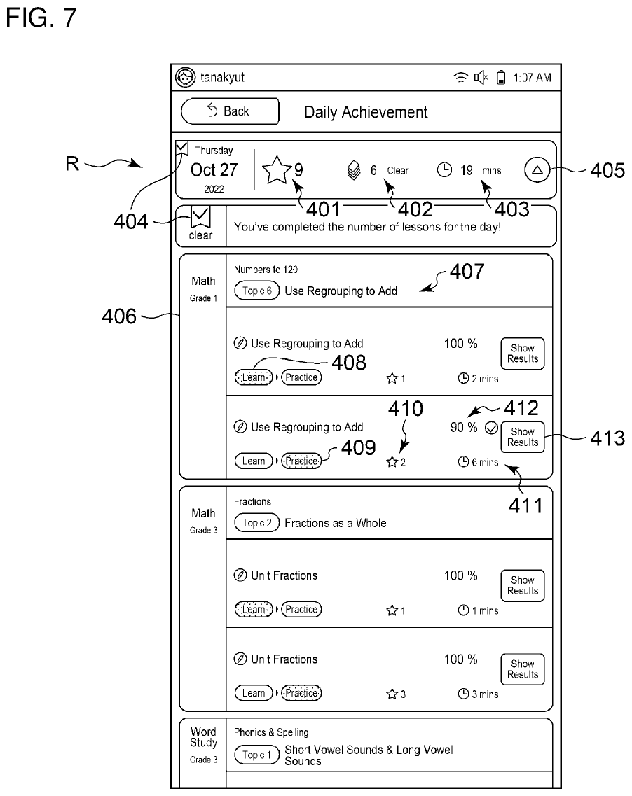

FIG. 7 shows the detailed information of the learning result R, which is displayed when the detail-showing button 405 for “Oct 27, 2022” (Oct. 27, 2022) shown in FIG. 5 is pressed. According to the data structure shown in FIG. 5, the detailed information of the multiple subjects including “Math (Grade 1)” and “Word Study (Grade 3)” are displayed from top to bottom. At least one learning topic 407 is displayed in each subject information display area 406. For example, in the subject information display area 406 for “Math (Grade 1)”, “Use Regrouping to Add (Topic 6)” is displayed as the learning topic 407 according to the data structure shown in FIG. 5.

As in the illustrated example, each learning topic 407 may be configured by multiple steps or phases, such as a learn step 408 or a practice step 409. In this case, each time the learner completes each step, the aforementioned cleared number 402 is incremented by one. In other words, in case each learning topic 407 is configured by the two steps 408 and 409, as in the example shown in the figure, when the learner completes the two steps 408 and 409 of each learning topic 407, the cleared number 402 is incremented by 2.

In the display area of each step 408 and 409, the number of rewards 410 earned by the learner according to his/her performance etc. and the learning time 411 of each of the steps 408 and 409 are summarized. The sum of the number of rewards 410 of all steps 408 and 409 of all learning topics 407 is equal to the number of rewards 401 for the learning day, and the sum of the learning time 411 of all steps 408 and 409 of all learning topics 407 is equal to the learning time 403 for the learning day.

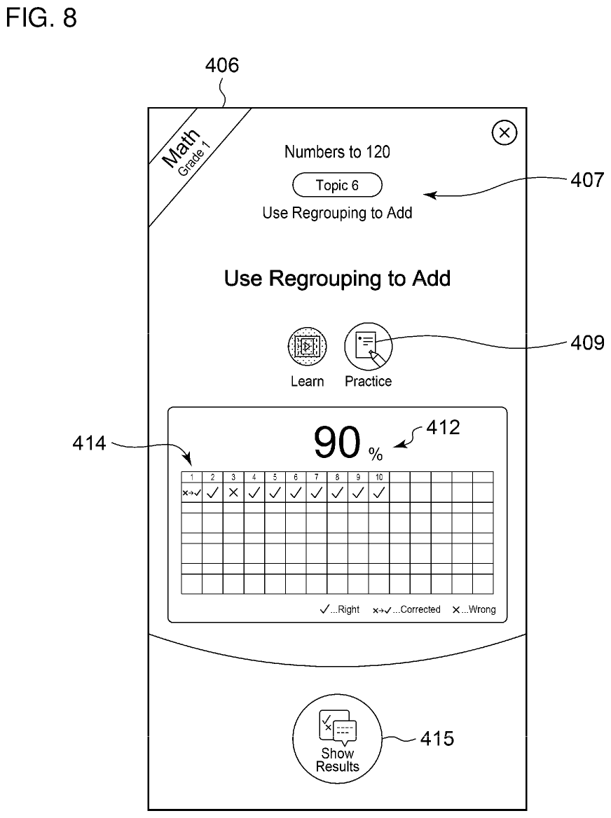

Besides, in the display area of each step 408 and 409, an achievement level 412 of each of the steps 408 and 409 is displayed. The achievement level 412 in the learn step 408 may be, for example, a percentage of the learning material that the learner has finished reading for the type of learning contents where the learner is required to read the learning material displayed on the learner terminal 120 (the display 224A), or a percentage of the lecture video that the learner has finished watching for the type of learning contents where the learner is required to watch the lecture video played on the learner terminal 120. Besides, the achievement level 412 in the practice step 409 may be, as described below, the percentage of correct answers or the total scores for one or more learning tasks Q finished by the learner in the practice step 409. When the result display button 413 is pressed on the display 224A, the screen transitions to the summary screen (FIG. 8) of the learning result R on which the achievement level 412 is based.

FIG. 8 is the result summary screen for the practice step 409 of the learning topic 407 “Use Regrouping to Add (Topic 6)”. The result summary 414 shows the summary of correctness, score, and the like for the 10 learning tasks “Q1” to “Q10” finished or answered by the learner in the practice step 409, according to the data structure shown in FIG. 5. The percentage of correct answers “90%” is displayed as the achievement level 412, in the example shown in the figure where the correctness (correct or incorrect) for the 10 learning tasks “Q1” to “Q10” is displayed in summary.

It should be noted that, as mentioned above with respect to FIG. 5, for the learning task “Q1”, the first answer was incorrect, but the second (the latest) answer was correct, therefore the final evaluation is “correct” being counted into the percentage of correct answers “90%”. However, for the purpose of effective review of the learning result R and the like, the change from the evaluation of the first answer (incorrect) to the evaluation of the second answer (correct) is displayed (from “X” (incorrect) to a check mark (correct)) in the result summary 414.

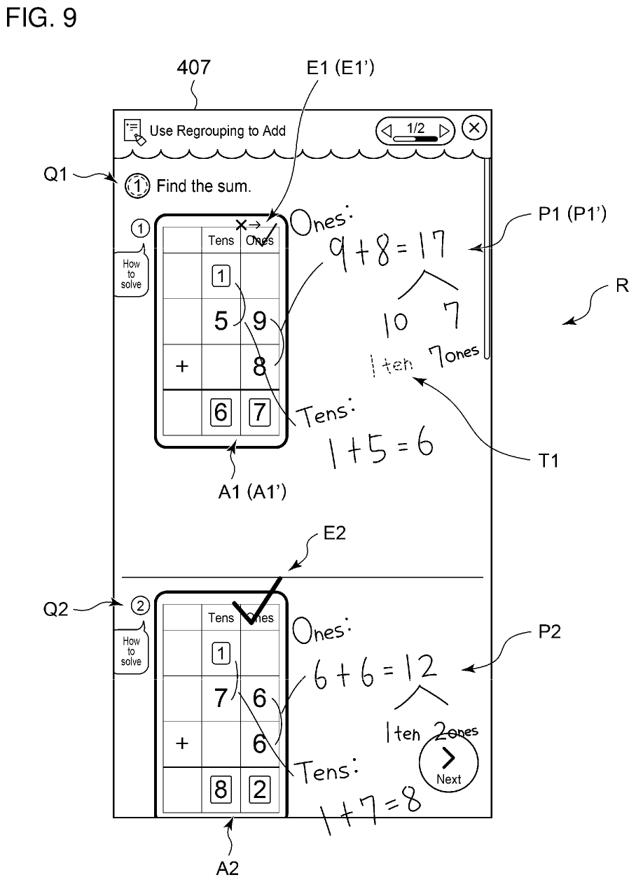

When a detailed result display button 415 is pressed on the display 224A, the screen transitions to show the detailed learning result R (FIG. 9 to FIG. 12) for each learning task “Q1” to “Q10” in the result summary 414.

FIG. 9 is the screen showing the detailed learning result R for the learning tasks “Q1” and “Q2”. The learning task “Q1” is to solve the addition “59+8” and the correct answer is “67”. Since the learner has input the correct answer “A1 (A1′)” being “67” through the learner terminal 120 (in particular, the touch panel 224B), the evaluation “E1 (E1′)” (check mark) is given by the learning assist apparatus 100 indicating that the answer is correct. In this way, the learning result presentation unit 300 in FIG. 4 displays the learner's answer such as A1 to the learning task such as Q1, and the evaluation such as E1 to the answer on the same screen (the display 224A).

Besides, the learning result presentation unit 300 displays on the same screen (the display 224A) the answer such as A1 by the learner to the learning task such as Q1, and the process information such as P1 input by the learner to the learner terminal 120 during the process of deriving the answer. The process information “P1 (P1′)” in the illustrated example is the handwriting information that the learner input on the touch screen 224 (the touch panel 224B) during the process of deriving the answer “A1 (A1′)” being “67”. Specifically, the handwritten calculation process to derive the answer “67” is displayed as the handwriting information “P1 (P1′)”, on the same screen as the learning task “Q1”, the answer “A1 (A1′)”, and the evaluation “E1 (E1′)”.

For example, by referring to the handwriting information “P1 (P1′)” displayed on the review terminal 120/150 (the display 224A), the assistant such as the guardian of the learner can grasp not only the mere correctness of the answer “A1 (A1′)” but also the appropriateness of the calculation process, to give appropriate advice or guidance according to the learner's level of understanding and the like. During the review of the learning result R, the assistant may write the advice “T1” on the review terminal 120/150 (the touch panel 224B) to teach the learner the appropriate calculation process or thinking process. For example, when the assistant writes the advice “T1” on the assistant terminal 150 (the touch panel 224B) as the review terminal, this advice “T1” is displayed on the learner terminal 120 (the display 224A) also as the review terminal.

It should be noted that, as described above with respect to FIG. 5 or FIG. 8, for the learning task “Q1”, the first answer was incorrect (“X”) being different from “67” (not shown), but the second (the latest) answer was correct (check mark), therefore the change from the evaluation of the first answer (incorrect) to the evaluation of the second answer (correct) is displayed (from “X” (incorrect) to a check mark (correct)) as the evaluation “E1 (E1′)”. In this way, the learning result presentation unit 300 in FIG. 4 displays the change from the previous evaluation (from E1 to E1′), for the second and subsequent answers (A1′ and the like) to the learning task (Q1 and the like) by the learner, on the same screen as the learning task (Q1 and the like), the answer (A1 (A1′) and the like), or the process information (P1 (P1′) and the like).

The learning task “Q2” is to solve the addition “76+6” and the correct answer is “82”. Since the learner has input the correct answer “A2” being “82” through the learner terminal 120 (in particular, the touch panel 224B), the evaluation “E2” (check mark) is given by the learning assist apparatus 100 indicating that the answer is correct. Besides, the learning result presentation unit 300 in FIG. 4 displays on the same screen (the display 224A) the answer such as A2 by the learner to the learning task such as Q2, and the process information such as P2 input by the learner to the learner terminal 120 during the process of deriving the answer. The process information “P2” in the illustrated example is the handwriting information that the learner input on the touch screen 224 (the touch panel 224B) during the process of deriving the answer “A2” being “82”. Specifically, the handwritten calculation process to derive the answer “82” is displayed as the handwriting information “P2”, on the same screen as the learning task “Q2”, the answer “A2”, and the evaluation “E2”.

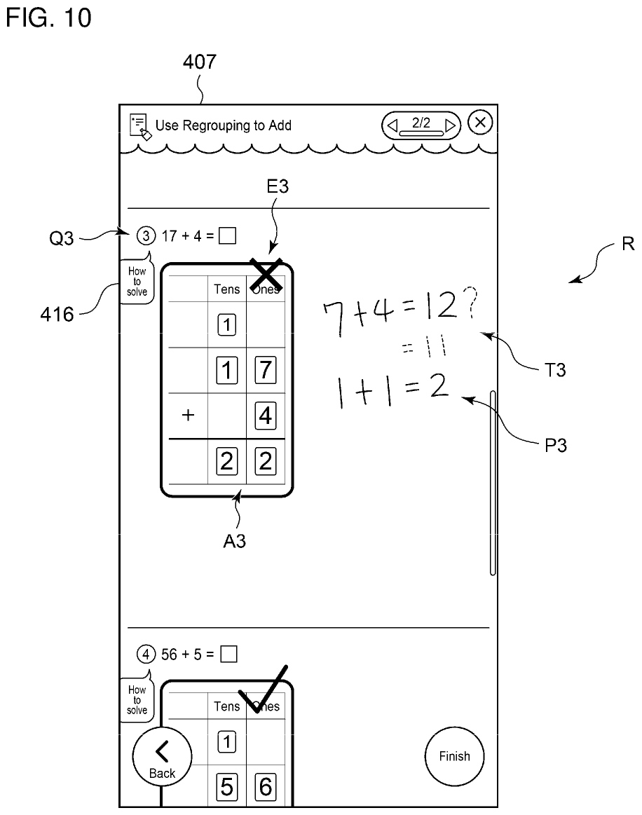

FIG. 10 is the screen showing the detailed learning result R for the learning task “Q3”. The learning task “Q3” is to solve the addition “17+4” and the correct answer is “21”. Since the learner has input the incorrect answer “A3” being “22” through the learner terminal 120 (in particular, the touch panel 224B), the evaluation “E3” (“X”) is given by the learning assist apparatus 100 indicating that the answer is incorrect. In this way, the learning result presentation unit 300 in FIG. 4 displays the learner's answer such as A3 to the learning task such as Q3, and the evaluation such as E3 to the answer on the same screen (the display 224A).

Besides, the learning result presentation unit 300 displays on the same screen (the display 224A) the answer such as A3 by the learner to the learning task such as Q3, and the process information such as P3 input by the learner to the learner terminal 120 during the process of deriving the answer. The process information “P3” in the illustrated example is the handwriting information that the learner input on the touch screen 224 (the touch panel 224B) during the process of deriving the answer “A3” being “22”. Specifically, the handwritten calculation process to derive the answer “22” is displayed as the handwriting information “P3”, on the same screen as the learning task “Q3”, the answer “A3”, and the evaluation “E3”.

For example, by referring to the handwriting information “P3” displayed on the review terminal 120/150 (the display 224A), the assistant such as the guardian of the learner can grasp not only the mere correctness of the answer “A3” but also the appropriateness of the calculation process, to give appropriate advice or guidance according to the learner's level of understanding and the like. During the review of the learning result R, the assistant may write the advice “T3” on the review terminal 120/150 (the touch panel 224B) to teach the learner the appropriate calculation process or thinking process. For example, when the assistant writes the advice “T3” on the assistant terminal 150 (the touch panel 224B) as the review terminal, this advice “T3” is displayed on the learner terminal 120 (the display 224A) also as the review terminal.

As in the example of FIG. 10, in case an answer such as A3 contains an error, the learning result presentation unit 300 in FIG. 4 may display a method for deriving a correct answer (corresponding to the correct answer derivation method S in FIG. 4) on the display 224A of the review terminal 120/150. Specifically, when a correct answer derivation method display button 416 on the display 224A of at least the assistant terminal 150 as the review terminal 120/150 is pressed on the display 224A, the correct answer derivation method “S3” for the corresponding learning task “Q3” is displayed on the display 224A.

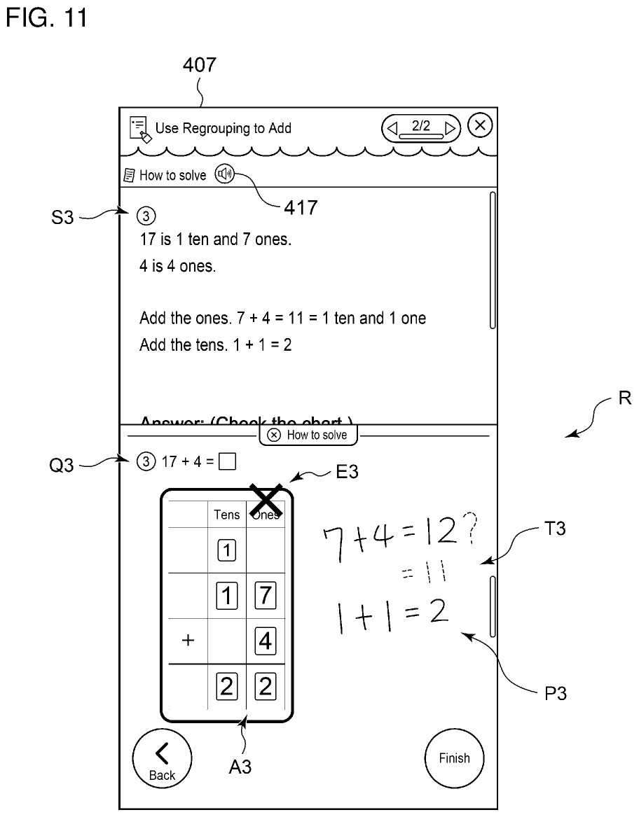

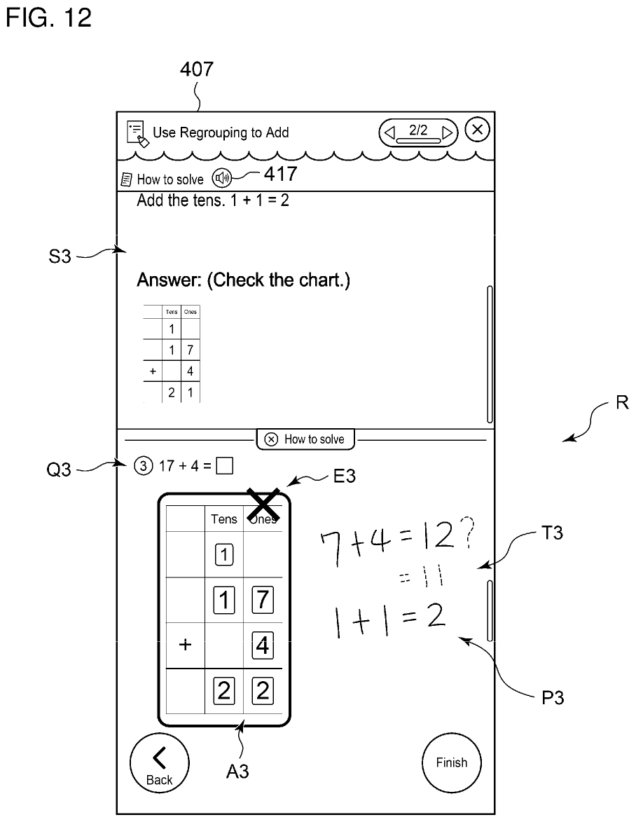

FIGS. 11 and 12 show the correct answer derivation method “S3” that is displayed on the display 224A by pressing the correct answer derivation method display button 416. In the example shown in the figures, the correct answer derivation method “S3” is displayed on the same screen at the top of the display 224A, with the learning task “Q3”, the answer “A3”, the evaluation “E3”, the process information “P3”, and the like being displayed at the bottom of the display 224A. The display area of the correct answer derivation method “S3” can be scrolled, allowing the assistant and/or the learner to view the explanatory information as shown in FIG. 11 and the correct answer information as shown in FIG. 12 on the review terminal 120/150. For example, the explanatory information in the correct answer derivation method “S3” (FIG. 11) corresponds to the process information “P3”, and the correct answer information in the correct answer derivation method “S3” (FIG. 12) corresponds to the answer “A3”, so that the assistant can provide appropriate advice or guidance to the learner to fill the gaps by comparing the displayed information on the single screen.

Besides, when the audio playback button 417 displayed in the display area of the correct answer derivation method “S3” is pressed on the display 224A, the speaker 226 of the review terminal 120/150 may play a voice reading out the correct answer derivation method “S3”. It should be noted that, in case both the learner terminal 120 and the assistant terminal 150 are used as the review terminals, the correct answer derivation method such as S3 and/or the correct answer derivation method display button 416 may be displayed only on the assistant terminal 150. The assistant can provide appropriate advice or guidance to the learner (the learner terminal 120) while referring to the correct answer derivation method such as S3 on the assistant terminal 150 (the display 224A).

The present invention has been described above based on embodiments. It is obvious to those skilled in the art that various variations are possible in the combination of each component and/or each process in the exemplary embodiments, and that such variations are also encompassed within the scope of the present invention.

In the examples shown in FIGS. 9 to 12, the handwriting information input by the learner on the touch panel 224B during the process of deriving the answer A has been exemplified as the process information P (FIG. 4), but any information input by any input means (the microphone 225, the camera 227, the sensor 228, and the like) of the learner terminal 120 other than the touch panel 224B may be utilized as the process information P. Such process information P do not necessarily have to be directly related to the answer A. For example, the microphone 225, the camera 227, the sensor 228, and the like can record the process information P of how the learner worked on the learning task Q. Even if no meaningful handwriting information is recorded as the process information P for a learning task Q, if the process information P obtained by the microphone 225, the camera 227, the sensor 228, and the like suggests that the learner was particularly struggling with the specific learning task Q, the assistant such as the learner's parent can concentrate on such learning task Q when providing guidance to the learner.

In the examples shown in FIGS. 9 to 12, examples have been given of the arithmetic learning tasks Q for which the process information P is recorded mainly as handwriting information, but the present invention can also be applied to learning tasks Q for which the process information P is recorded mainly as information other than handwriting information, such as audio information or voice information acquired by the microphone 225 or gesture information acquired by the camera 227. For example, in a learning task Q in which letters or sentences are required to read out loud, the audio information or voice information that the learner input to the learner terminal 120 (the microphone 225) during the process of deriving the answer A can be utilized as the process information P. Besides, in a learning task Q in which one or more objects are required to rearranged, moved, transformed, combined, and the like on the display 224A, the operation information that the learner conducted on the learner terminal 120 (the touch panel 224B) for the one or more objects during the process of deriving the answer A can be utilized as the process information P.

Although the examples in FIGS. 9 to 12 have illustrated the process information P during the practice step 409, the similar process information P can be utilized in the learn step 408. For example, in the learn step 408, handwriting information such as memo, note, and the like written by the learner through the learner terminal 120 (the touch panel 224B), while reading the learning material (reading material) displayed on the learner terminal 120 or while watching the lecture video played on the learner terminal 120, may be recorded as the process information P and referred to when reviewing the result R.

In the examples of FIGS. 9 to 12, the process information P has been used for the review of the learning result R by a person (the learner and/or the assistant), but the process information P may be provided to an artificial intelligence that can be implemented in the server 110 and the like. For example, an artificial intelligence equipped with a machine learning function can precisely understand the learner's level of understanding or weakness (issue), by referring to the process information P together with the answer A or the evaluation E for each learning task Q. Such knowledge or insight is extremely important for customizing or personalizing learning contents for each learner.

It should be noted that the structures, the operations, and the functions of each apparatus and/or each method described in the embodiments can be realized by hardware resources or software resources, or by the cooperation of hardware resources and software resources. As hardware resources, for example, processors, ROMs, RAMs and various integrated circuits can be used. As software resources, for example, programs such as operating systems and applications can be used.
100 learning assist apparatus, 110 server, 120 learner terminal, 130 touch pen, 140 network, 150 assistant terminal, 214A learning contents database, 214B learning history database, 214C subscriber database, 224 touch screen, 224A display, 224B touch panel, 225 microphone, 226 speaker, 227 camera, 228 sensor, 300 learning result presentation unit.

What is claimed is:

1. A learning assist apparatus comprising at least one processor that performs, by a learning result presentation unit, presenting a learning result performed by a learner through a learner terminal, wherein
the learning result includes an answer by the learner to a learning task and process information input by the learner to the learner terminal during the process of deriving the answer.

2. The learning assist apparatus according to claim 1, wherein
the learner terminal is equipped with a touch screen, and
the process information is information input by the learner on the touch screen during the process of deriving the answer.

3. The learning assist apparatus according to claim 1, wherein the process information is handwriting information input by the learner to the learner terminal during the process of deriving the answer.

4. The learning assist apparatus according to claim 1, wherein the process information is audio information input by the learner to the learner terminal during the process of deriving the answer.

5. The learning assist apparatus according to claim 1, wherein the learning result presentation unit presents the learning result through the learner terminal.

6. The learning assist apparatus according to claim 1, wherein the learning result presentation unit presents the learning result through an assistant terminal used by an assistant who assists the learner.

7. The learning assist apparatus according to claim 1, wherein the learning result presentation unit displays the answer and the process information on the same screen.

8. The learning assist apparatus according to claim 7, wherein the learning result presentation unit displays an evaluation of the answer on the same screen.

9. The learning assist apparatus according to claim 8, wherein the learning result presentation unit displays on the same screen a change from the previous evaluation, for the second and subsequent answers to the learning task by the learner.

10. The learning assist apparatus according to claim 7, wherein the learning result presentation unit displays a method for deriving a correct answer at least when the answer contains an error.

11. The learning assist apparatus according to claim 1, wherein the learning result presentation unit presents the learning result for each predetermined learning unit.

12. The learning assist apparatus according to claim 11, wherein the learning result presentation unit presents the learning result for each predetermined unit learning period.

13. A learning assist method comprising, presenting a learning result performed by a learner through a learner terminal, wherein
the learning result includes an answer by the learner to a learning task and process information input by the learner to the learner terminal during the process of deriving the answer.

14. A computer-readable medium storing a learning assist program causing a computer to perform, presenting a learning result performed by a learner through a learner terminal, wherein
the learning result includes an answer by the learner to a learning task and process information input by the learner to the learner terminal during the process of deriving the answer.
